(19) United States
(12) Patent Application Publication
(10) Pub. No.: US 2010/0319514 A1
(43) Pub. Date: Dec. 23, 2010

(54) UNEVENLY-SPACED BRIDGE SYSTEM FOR GUITAR

(76) Inventor: Daniel J. AIRES, Prairie Village, KS (US)

Correspondence Address: GREENBERG TRAURIG, LLP (DC/ORL), 2101 L Street, N.W., Suite 1000, Washington, DC, 20037, US

(21) Appl. No.: 12/820,674

(22) Filed: Jun. 22, 2010

Related U.S. Application Data
(60) Provisional application No. 61/219,663, filed on Jun. 23, 2009.

(51) Int. Cl. G10D 3/04

(52) U.S. Cl. 84/298

(57) ABSTRACT

The invention provides an unevenly-spaced bridge system for a guitar. The bridge system in one embodiment includes a base plate with at least four and preferably five saddles thereon. A first centrally located saddle on the base plate supports a first central string that is typically a wound string, and a second centrally located saddle on the base plate supports a second central string that is typically an unwound string. The first and second centrally located saddles are individually adjustable for intonation. A shared saddle on the plate supports a pair of high strings, typically the high E string and the B string. The disclosed design thus provides the capability for at least the two high strings of the guitar to be supported by a shared saddle, while other strings are individually adjustable for intonation. In this manner, the invention provides an optimal balance between tone and tuning.

This application claims the benefit of U.S. Provisional Patent Application No. 61/219,663 filed Jun. 23, 2009, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates to the field of saddle-on-base-plate adjustable bridges for solid or semi-hollow-body musical instruments.

### BACKGROUND

Bridge systems for guitars, e.g. six-string electric guitars, typically fall into one of three categories. The first category of bridge utilizes a base plate with three evenly spaced openings for three individual saddles, one for each two strings. This design dates from the 1950s. This arrangement has an important advantage for the two thinnest, highest strings, described below. These high/thin strings are also called the treble strings. The typical gauges are 0.08-0.15, and they are generally tuned to B and high-E. The advantage arises because the combined downward force exerted by the two thinnest strings is roughly twice a strong as would be possible if each high/thin string had its own saddle. This increased downward force on their shared saddle results in stronger saddle-to-bridge-base contact. This stronger contact results in a cutting tone, sometimes described as “twang” or “spank”. This cutting tone is especially important for the highest pitched notes, which are played mainly on the thinnest strings. In fact, many critics complain that the six-saddle arrangement causes poor tone and sustain for the two thinnest strings. However, there is a corresponding disadvantage to the three-saddle bridge: loss of individualized intonation. Since adjusting the intonation for a given string simultaneously results in changing the intonation for the adjacent string with which it shares a saddle, it becomes cumbersome if not impossible to accurately intonate a 6-string instrument with a three-saddle bridge. This disadvantage is particularly pronounced for the lower, thicker strings, especially the D and G which are often quite out of tune using this arrangement, due mainly to their very different diameters; generally modern strings sets use a wire-wound D, and a non-wound G. Because the highest/thinnest two strings (B and high-E) are both unwound, it is relatively easy to intonate the highest/thinnest strings using a shared angled saddle for both strings.

The second category of bridge systems provides a base plate with six evenly-spaced openings for six individual saddles, one for each string. This design dates from the 1960s. This arrangement has the advantage of allowing individualized intonation for each string, resulting in the instrument being more “in tune.” This is important for playing pleasing chords. The six-saddle arrangement has the following disadvantage: instead of two strings putting their combined force on their shared saddle, each saddle is held only by the force from a single string. This causes weaker saddle-to-bridge-base contact and decreased tone. This is especially noticeable in regard to the two thinnest/highest strings (treble, usually B and high-E), since these strings produce the high notes that are important for producing the desired tonal “twang” or “spank.”

The third category of bridge systems is known as the Parson-White B-bender. Such bridges include three evenly-spaced saddles, with the top one modified to allow individual movement of the second-thinnest string (the “B” string). This design dates from the late 1960s. This design does not provide the intonation advantages of individual saddles for the lower strings. It also loses some of the desired tonal “twang” or “spank” since the highest and thinnest two strings are not as firmly anchored as they are in the unmodified three-saddle arrangement discussed above.

The following US patents and published applications relate to saddle-on-base-plate adjustable bridges for stringed instruments.

U.S. Pat. No. 2,573,254 filed Jan. 13, 1950 describes a sectional bridge with three barrel-style saddles for six strings, and string-through body construction.

U.S. Pat. No. 2,972,923 filed Nov. 6, 1958 describes a floating bridge with six barrel-style saddles for six strings.

U.S. Pat. No. 3,479,917 filed Dec. 15, 1967 describes a lever-operated string-bender.

U.S. Pat. No. 7,329,808 filed Mar. 25, 2005 describes a string-bender, and makes reference to the well-known B-bender.

U.S. Pat. No. 3,686,993 filed Jan. 11, 1971 describes a shoulder-strap-operated string-bender.

U.S. Pat. No. 4,031,799 filed Jan. 26, 1976 describes the Fender 6-barrel bridge with a saddle-lock.

U.S. Pat. No. 4,128,033 filed Jul. 25, 1977 describes individual small barrel-shaped saddles, for use in a multi-saddle bridge.

The references discussed above describe bridge designs having evenly-spaced saddles.

### SUMMARY

In one embodiment, the invention provides an unevenly-spaced bridge system for a guitar. The bridge system includes a base plate with at least four and preferably five saddles thereon. A first centrally located saddle on the base plate supports a first central string that is typically a wound string, and a second centrally located saddle on the base plate supports a second central string that is typically an unwound string. The first and second centrally located saddles are individually adjustable for intonation. A shared saddle on the plate supports a pair of high strings, typically the high E string and the B string.

The disclosed design thus provides the capability for at least the two high strings of the guitar to be supported by a shared saddle, while other strings are individually adjustable for intonation. In this manner, the invention provides an optimal balance between tone and tuning.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a top plan view illustrating an embodiment of the disclosed bridge with round saddles.

FIG. 2 shows a perspective view of the embodiment of FIG. 1.

FIG. 3 shows a top plan view illustrating an alternate embodiment of the invention with round saddles.

FIG. 4 shows a perspective view of the alternate embodiment of FIG. 3.

FIG. 5 shows a top plan view illustrating of another alternate embodiment of the invention with box saddles.

FIG. 6 shows a perspective view of the alternate embodiment of FIG. 5.

FIG. 7 shows a top plan view illustrating an embodiment of the invention with a mix of four different saddles.

FIG. 8 shows a top plan view illustrating an alternate embodiment of the invention with a mix of four different saddles.

FIG. 9 shows a perspective view of a bridge with eleven evenly spaced holes, six of which can be left empty to achieve an effect similar to the uneven spacing illustrated in FIG. 1 through 8.

FIG. 10 shows a perspective view of the bridge shown in FIG. 9, but with saddles and screws in place.

FIG. 11 shows a top plan view illustrating an embodiment of the invention mounted on a guitar.

FIG. 12 shows a top plan view illustrating an alternate embodiment of the invention mounted on a guitar.

FIGS. 13 and 14 show an alternate embodiment of the invention wherein a shared saddle is provided for the fifth and sixth strings, a second shared saddle is provided for the first and second strings, and the central stings have individually-adjustable saddles.

### DETAILED DESCRIPTION

Reference will now be made in detail to the preferred embodiments of the present invention, examples of which are illustrated in the accompanying drawings.

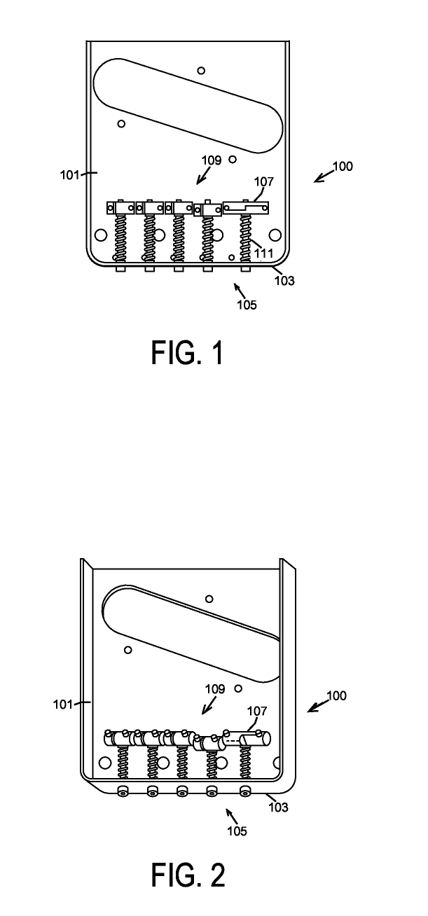

FIG. 1 shows a bridge 100 in accordance with one embodiment of the invention. The bridge 100 comprises a plate 101, which may be metal, graphite, or other hard material. The plate 101 is secured to the body of an instrument. The plate has a flanged end 103. The plate base is apertured to receive the ends of the strings as they pass into the bridge from the body. Alternatively, the flanged end may be apertured to receive the string ends. The heads of five unevenly spaced adjusting screws 105 protrude through the flanged end. Each adjusting screw is screwed into one of the saddles 107, 109, and provides the ability to adjust the intonation of its respective saddle. The saddle 107 is a shared saddle, which is occupied by two strings, while the saddles 109 are individual saddles which are occupied by a single string and are individually adjustable for intonation via the screws 105. The saddles 107, 109 are each held in place horizontally by the opposing forces of (a) string tension and (b) the flanged end. Each adjusting screw 105 is surrounded by a circumferential spring 111 which provides the ability to adjust its saddle when a string is not mounted. Each saddle is positioned vertically by the adjustment of two integrated screws.

In one embodiment, the base plate 101 has four closely-spaced openings that are approximately 7/16th inch apart, but this distance depends on the saddle-type used in the embodiment. These openings are for four individual saddles 105 for the four thicker/lower strings (bass, usually low-E, A, D, G). A fifth opening is more distantly-spaced. This more-distant spacing depends on the four single-string saddles used in the particular embodiment, but is generally 11/16th inch. The latter opening is for a single shared saddle for the two thinner/higher strings (treble, usually B and high-E).

The two thinner/higher strings differ from the lower four in two key ways. First, these two strings make the largest contribution to the high end of the frequency spectrum, and are responsible for the “twang” or “spank” associated with the traditional bridge. Also, the second of these two strings (usually tuned to B) has less string tension than any of the other five strings, which can result in a weaker sound when it has a single non-shared saddle.

As above, the distance between each of the first four saddles could vary depending on the exact type of saddle used (see, e.g., FIGS. 7 and 8).

Each of the openings having upper shoulders formed in the side upper ends and lower shoulders formed in the side lower ends, and each of said saddles being positioned in a corresponding one of the openings. Each of the four single-string saddles, corresponding to the four lower/thicker strings, comprises a string receiving portion and a holding portion, the string receiving portion having a concave impression in its upper surface adapted to receive a guitar string, and having its lower surface engaged with and supported by said upper shoulders. The holding portion fits within the opening and has laterally extending flange portions resting on the lower shoulders. The holding portion has a threaded hole extending therethrough for receiving an adjusting screw. The adjusting screw extends in a fore-and-aft direction through the opening and through the threaded hole and is operable, upon rotation, to adjust the position of the saddle in a fore-and-aft direction, and to maintain the saddle in its adjusted position. A holding screw passes through the string-receiving portion and the holding portion, connecting the portions, and is operable upon tightening of the holding screw to maintain the string-receiving portion and the holding portion in firm contact with the upper shoulders and lower shoulders, respectively, to prevent undesired lateral or rotational movement of said saddle. The fifth double-string saddle is shared by the two higher/thinner strings. It is otherwise similar to the four saddles described above.

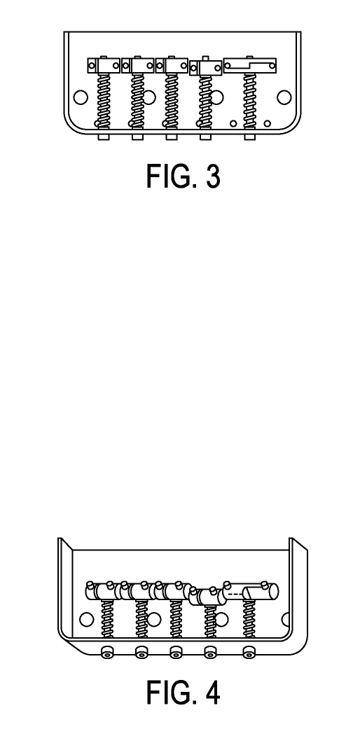

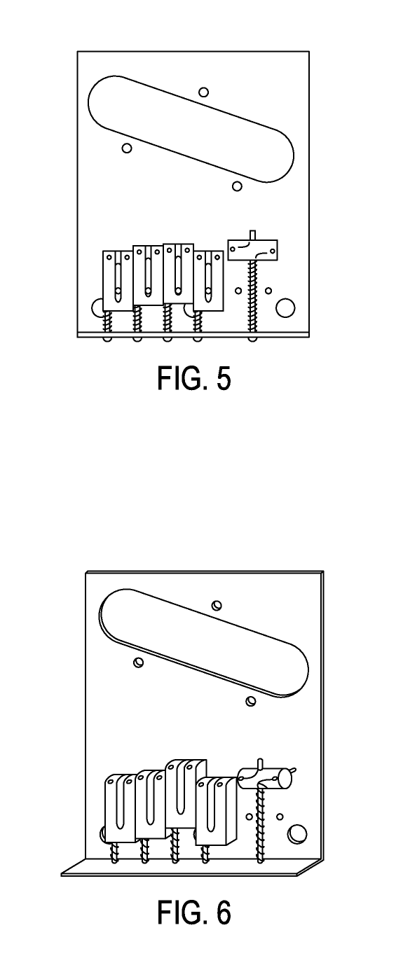

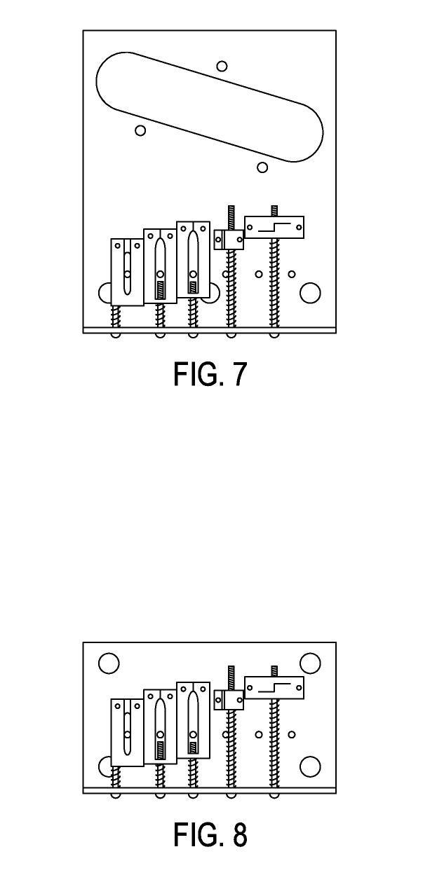

The invention can be used with various types of saddles. FIG. 3 shows an embodiment of the invention wherein round saddles are utilized. FIG. 4 shows a perspective view of the alternate embodiment of FIG. 3. FIG. 5 shows an alternate embodiment of the invention with box saddles. FIG. 6 shows a perspective view of the alternate embodiment of FIG. 5. FIG. 7 shows a first embodiment of the invention with a mix of four different saddles, and FIG. 8 shows an alternate embodiment of the invention with a mix of four different saddles.

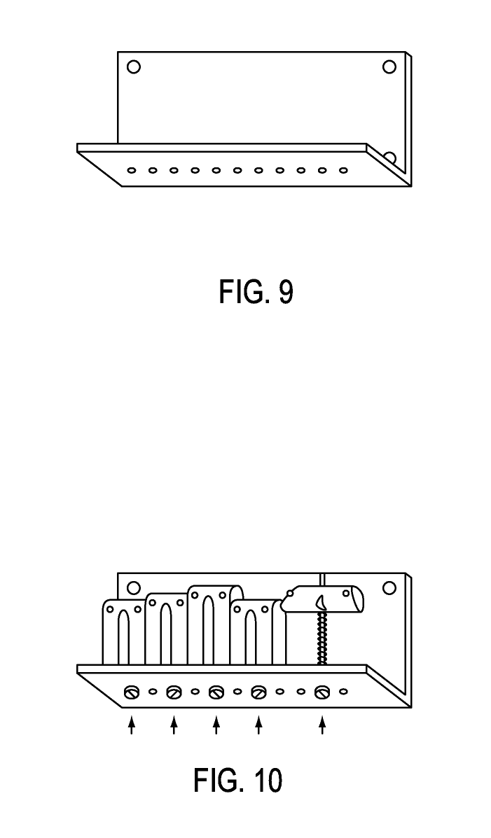

FIG. 9 shows a bridge comprising a base plate with eleven evenly spaced holes. By leaving six of the holes empty, a mix of individual saddles and at least one shared saddle can be utilized to achieve an effect similar to the uneven spacing illustrated in FIG. 1 through 8. FIG. 10 shows a perspective view of the bridge shown in FIG. 9, but with saddles and screws in place so as to provide such a configuration.

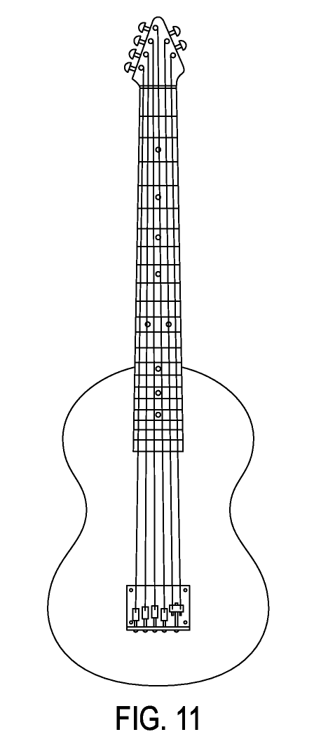

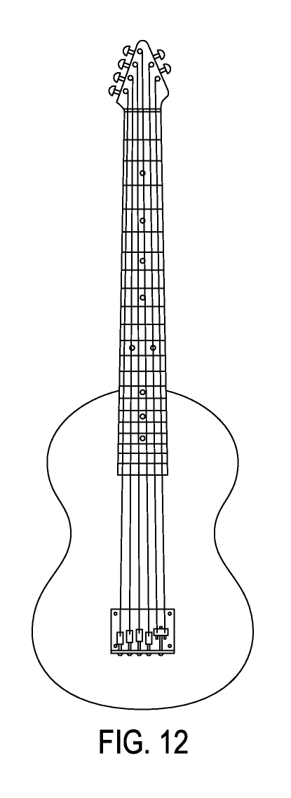

FIG. 11 shows a guitar having a bridge configured according the invention. FIG. 12 shows an alternate embodiment of a guitar having a bridge configured in accordance with the invention.

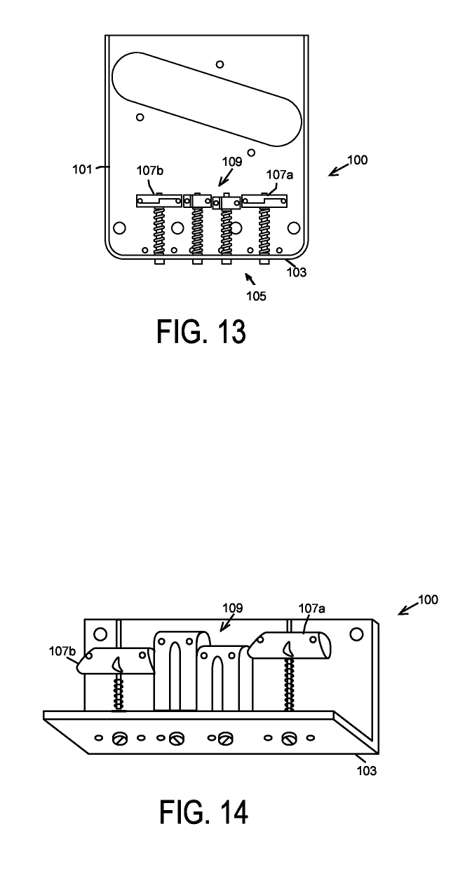

FIGS. 13 and 14 show alternate embodiments of the invention wherein a shared saddle 107a is provided for the first and second strings, a second shared saddle 107b is provided for the fifth and sixth strings, which are normally the A and low-E strings. In this embodiment, the central stings, D and G, have individually-adjustable saddles. Since D and G contain the transition from wound to unwound, providing individual intonation adjustments (e.g., via screws 105) for the D and G strings is important from an intonation perspective.

The invention in certain embodiments thus provides an unevenly-spaced five-saddle bridge for a six-stringed solid or semi-hollow-body musical instrument. The invention with its unique base-plate having unevenly-spaced openings for saddle-mounting has the advantages of optimizing the balance between intonation of the four lower (bass) strings where tone is less of a problem, and tone of the two higher (treble) strings, where intonation is less of a problem.

While the invention has been particularly shown and described with reference to a preferred embodiment thereof, it will be understood by those skilled in the art that various changes in form and details may be made therein without departing from the spirit and scope of the invention. For example, the invention can be applied to guitars having more than six strings, such as seven-string guitars.

What is claimed is:

1. An unevenly-spaced bridge system for a guitar, comprising:
a base plate;
a first centrally located saddle on said base plate, said first centrally located saddle supporting a first central string;
a second centrally located saddle on said base plate, said second centrally located saddle supporting a second central string;
said first and second centrally located saddles being individually adjustable for intonation; and,
a shared saddle on the plate, the shared saddle supporting a pair of high strings.

2. The unevenly-spaced bridge system according to claim 1, wherein the first centrally located saddle supports a wound string and the second centrally located saddle supports an unwound string.

3. The unevenly-spaced bridge system according to claim 1, wherein the pair of high strings comprise the high E string and the high B string.

4. The unevenly-spaced bridge system according to claim 1, wherein the guitar comprises a six-string guitar.

5. The unevenly-spaced bridge system according to claim 1, further comprising a second shared saddle on a pair of low strings.

6. The unevenly-spaced bridge system according to claim 1, wherein the plate is a metal plate.

7. The unevenly-spaced bridge system according to claim 1, wherein the plate a graphite plate.

8. The unevenly-spaced bridge system according to claim 1, wherein the plate is made of a hard material.

9. The unevenly-spaced bridge system according to claim 1, further comprising a shared low-E/A saddle, wherein the first and second central individual saddles support the D and G strings.

10. The unevenly-spaced bridge system according to claim 1, wherein the first saddle, the second saddle and the shared saddle have flat tops.

11. The unevenly-spaced bridge system according to claim 1, wherein the first saddle, the second saddle and the shared saddle have round tops.

12. An unevenly-spaced five-saddle bridge piece for a six-string guitar that provides twang in two strings and intonation balance, comprising:
a base-plate configured for use as a guitar bridge piece, the base plate having unevenly-spaced openings for saddle-mounting, with four individual saddles for the four thicker bass strings and a single shared saddle for the two thinner treble strings.

13. A bridge piece for a guitar that can be configured to provide both twang and intonation balance, comprising:
a base plate configured for use as a guitar bridge piece, the base plate having evenly-spaced openings for saddle-mounting in excess of the number of saddles to allow uneven spacing of the saddles by means of leaving some of the openings empty;
wherein the number of said evenly-spaced opening is more than the number of strings on the guitar.

14. The bridge for a guitar in accordance with claim 13, wherein the number of openings in the base plate is eleven and the number of strings is six.

15. A six-string guitar that provides twang in at least two strings and intonation balance, comprising:
a guitar body;
an unevenly-spaced five-saddle bridge mounted to the guitar body, the bridge further comprising:
a base-plate with unevenly-spaced openings for saddle-mounting, with four individual saddles for the four thicker bass strings and a single shared saddle for the two thinner treble strings.

16. The guitar in accordance with claim 15, wherein the guitar is a solid-body guitar.

17. The guitar in accordance with claim 15, wherein the guitar is a semi-hollow-body guitar.
